(19) United States
(12) Patent Application Publication
(10) Pub. No.: US 2002/0054027 A1
(43) Pub. Date: May 9, 2002

(54) Display system

(76) Inventors: David Porter, London (GB); Richard Langan, London (GB)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/882,318

(22) Filed: Jun. 15, 2001

(30) Foreign Application Priority Data
Oct. 12, 2000 (GB) 0024977.1

(51) Int. Cl. G09G 5/00

(52) U.S. Cl. 345/173

(57) ABSTRACT

A display system for displaying simultaneously multiple images, while providing a user of the system with the facility to select the images to be displayed, the system including a display screen, on which are displayed a plurality of windows, there being a databank of data files, each data file including image data relating to one or more images each of which is displayable on the display screen, the display screen including at least one selection area, a touch sensor to sense when the or a part of the selection area has been touch selected by a user, the system in response displaying in a window, a corresponding image.

### BACKGROUND TO THE INVENTION

This invention relates to a display system, and more particularly to a display system which is capable simultaneously of displaying images. Such a display system may be used for advertising purposes, although is suitable for use for displaying other information.

More particularly, but not exclusively, the invention has been developed for use in displaying multiple images relating to properties in estate agents' shop windows.

### DESCRIPTION OF THE PRIOR ART

Presently, estate agents place in their shop windows, photographs with some textual information, of properties they are selling or letting for their customers. Each such photograph and accompanying text can give only outline information of the property, and if a potential purchaser requires more information, such further information may be gleaned from the estate agent during working hours, and/or a site visit can be made.

Only being able to obtain farther information from the estate agent during working hours can be troublesome enough, but generally, a potential property purchaser or tenant has to make several visits to sites which may be in different parts of a region, which is very time consuming, in order to find an acceptable property.

### SUMMARY OF THE INVENTION

According to one aspect of the present invention we provide a display system for displaying simultaneously multiple images, whilst providing a user of the system with the facility to select the images to be displayed, the system including a display screen, means to display on the display screen a plurality of windows, there being a databank of data files, each data file including image data relating to one or more images each of which is displayable in a window of the display screen, means to display on the display screen at least one selection area, means to sense when the or a part of the selection area has been touch selected by a user, and the system being adapted to respond by displaying in a window, a corresponding image.

By providing the display screen where a potential customer may touch select a part of the selection area, even when for example, the estate agents' shop is closed, a potential property purchaser or tenant may interactively obtain information on properties and/or more information on a property. For example, the display screen may be mounted on or immediately adjacent to a shop window, so that parts of the selection area of die display screen may be touch selected by touching the shop window. Where the image information is sufficiently informative, a potential property purchaser or tenant for examples, may be saved from making site visits to properties which are unsuitable.

In a preferred embodiment, the images which are displayed in the windows, are moving images, for example of properties, the images having been previously obtained by recording the images with one or more analogue and/or digital video cameras. In one arrangement, the images are tours through properties.

Where a property includes more than one part, e.g. rooms, a room in which the tour may start may be selected by a user touching a part of the selection area which indicates the selected part or room.

If desired images of different parts of a property may be displayed in the respective windows of the display screen, depending on a selection made by a user touching a part of the selection are of the display screen.

If desired, different pails of a property may be depicted e.g. by a map or floor plan displayed on the screen, and in the selection area of the display screen, means mall be provided so that a user may select a part of the property from where the user requires to commence a tour. Thus by touching a selected part of the selection area a user may control a tour through the property displayed by an image in a window of the screen.

Thus tours of different parts of a property may be displayed in a window or windows, by recalling relevant image files from the databank and displaying them in a window displayed by the display screen.

Preferably the display screen displays a plurality of selection areas simultaneously. Whereas touch selecting different parts of the selection areas may enable a particular image to be displayed in a window of the display means, another pail of the selection areas when selected by touch, may enable an image being displayed to be manipulated, e.g. scrolled backwards or forwards, zoomed in or out etc.

It will be appreciated that although the invention has thus far been described particularly with reference to a display system suitable for use in an estate agents' business, the invention may be used for a travel agents' business in which case the images displayed may be of holiday destinations, and/or properties which may be let in the course of a holiday, or the invention may be used in a retailing business for displaying images of products for sale, such as catalogue items, films, videos or the like.

Thus the invention may be used as a browser to select from a databank of image files, one or more images to view in the windows of the display screen.

In each case, the databank of data files will require frequent updating. This may be achieved by manually loading media (discs etc.) into a reader machine connected to the display system, or preferably by uploading data files from a data store, via a dedicated or dial-up telecommunications network.

In one embodiment the display screen is an L.C.D. or plasma type display screen which may be mounted immediately adjacent a shop window pane, but with a transparent touch sensitive means such as a capacitive grid layer between the L.C.D. or plasma screen and the window pane, the touch sensitive means being capable of sensing which part of the selection area of the display screen has been touched, albeit from an opposite side of the window pane, and providing an appropriate signal to a processing means which responds by recalling relevant data from the databank for displaying in the or a window displayed on the display screen.

In another embodiment, the capacititive layer or other touch sensitive means may be adhered directly to an interior surface of the shop window pane, with the L.C.D. or plasma screen mounted directly behind

According to a second aspect of the present invention we provide a display system for displaying simultaneously multiple images, whilst providing a user of the system with the facility to select tie images to be displayed, the system including a main display screen, means to display on the main display screen a plurality of windows, there being a databank of data files, each data file including image data relating to one or more images each of which is displayable on the display screen, means to display on a separate ancillary display screen at least one selection area, means to sense when the or a part of the selection area has been touch selected by a user, and in response, to display in a window of the main display screen, a corresponding image, simultaneously with an image being displayed in another of the plurality of windows displayed on the main display screen.

Thus in accordance with the second aspect of the invention, a smaller ancillary touch sensitive display screen may be mounted e.g. in an estate agent's shop window, for controlling what is displayed on a much larger screen, such as a large plasma display screen mounted so as to be visible to a user, but if desired, spaced immediately away fi-on the shop window pane.

The display system of the second aspect of the invention may have many of the features of the display system of the first aspect of the invention.

According to a third aspect of the invention we provide a method of displaying multiple images on a display system, the images being digital images stored in data files in a data bank, the method including displaying, on a display screen, a window, and displaying on the or another display screen, at least one touch sensitive selection area, touching a or a part of the selection area to select an image or images are to be displayed in the window or the windows displayed on the display screen, and recalling image data from the data bank to enable the image or images to be displayed.

The method of the third aspect of the invention may utilise any of the features of the display system according to the first or second aspects of the invention.

According to a fourth aspect of the invention we provide a method of displaying images of properties on one or more display screens, including displaying a window in which an image of a property is to be displayed, displaying a map or floor plan of the property, providing touch-sensitive means whereby parts depicted by the map or floor plan are identified in a selection area displayed by the screen, selecting a part of the property of which it is desired to view an image by touching a selected part of the selection area corresponding to a part depicted by the map or floor plan, recalling from a data bank of image files, image data corresponding to the selected part of the property, and displaying in the displayed window, an image of the selected part of the property.

The method of the fourth aspect of the invention may utilise any of the features of the display system according to the first or second aspects of the invention.

### BRIEF DESCRIPTION OF THE DRAWINGS

The invention will now be described with the aid of the accompanying drawings in which:

FIG. 1 is a schematic view of a display system in accordance with the invention;

FIG. 2 is a view similar to FIG. 1, but of an alternative display system;

FIG. 3 is an illustrative side cross sectional view of the display system of FIG. 1 located in use;

FIG. 4 is a view similar to FIG. 3 but of an alternative embodiment.

### DETAILED DESCRIPTION OF THE PREFERRED EMBODIMENTS

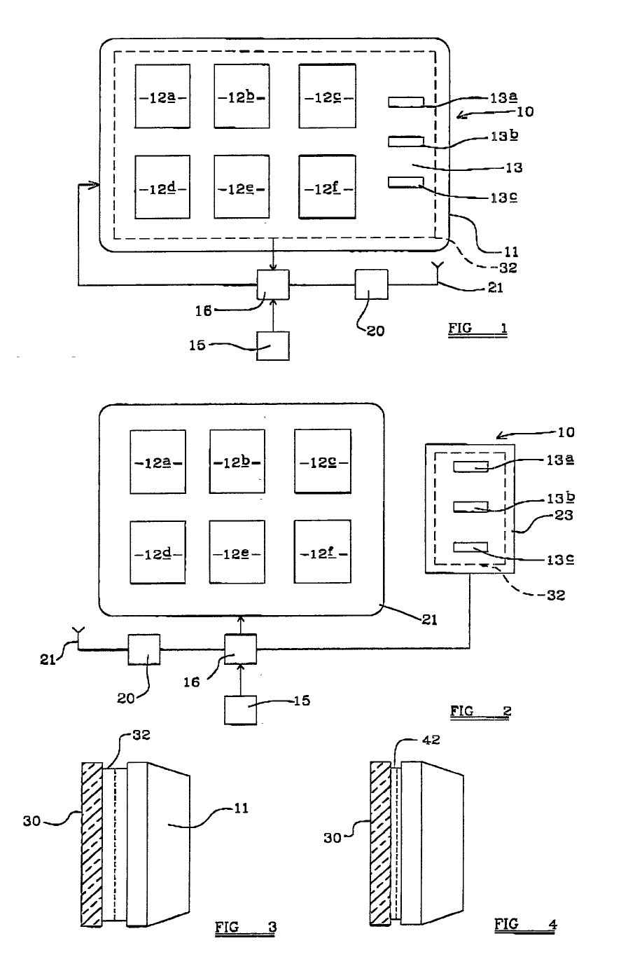

Referring to FIG. 1, a display system 10 is shown which is for use in displaying images relating to properties in a shop window of an estate agent.

The system 10 includes a single display screen 11, which may be an L.C.D. type screen, a plasma screen, or any other desired kind of display screen 11. FIG. 1 shows a typical display lay-out in which a plurality of windows, six in this example indicated at 12a to 12f, are displayed, together with a selection area 13. The windows 12a to 12f, are each capable of displaying independent and different images therein, typically moving images, of properties. Thus for example, images of, in this example six, different properties may be displayed simultaneously in the windows 12a to 12f.

The image information may be stored in a databank 15 of image files. Typically the image data will have been collected with one or more video cameras, and stored in a conventional digital video format. Alternatively or additionally, the images could be still images. A microprocessor 16 retrieves the image data and causes it to be displayed in the six widows 12a to 12f Other numbers of windows 12a to 12f may be displayed in alternatively arranged arrays to that shown in FIG. 1, as desired.

In order to attract a potential property purchaser or tenant to the system 10, moving images of randomly selected properties may be retrieved from the data bank 15 and displayed in blue six windows 12a to 12f.

In this example, the selection area 13 provides a menu, items of which may be selected by touch selecting different parts of the selection area 13. Thus a potential properly purchaser or tenant attracted to the display means 10 may interactively, obtain more information on the properties randomly displayed in the windows, 12a to 12f, or more particularly may provide certain selection criteria to the system 10, whereby images which match such selection criteria may be caused to be displayed on the display screen 11.

In one example, a menu of price ranges may for example be displayed, e.g. a first price range 13a, a second price range 13b and a third price range 13c although in practice a greater number of price ranges e.g. six price ranges, may be indicated. A user may touch an appropriate part 13a to 13c of the selection area 13 to select the user's desired price range. Next the selection area 13 may display the names of different towns/districts, for the user to select a desired location by touching. Next the selection area 13 may display property type options, e.g. flat or house, and/or number of bedrooms etc. and the user may again select options by touching a relevant part of the selection area 3.I When the selection criteria has all been input, the microprocessor 16 will select matching properties, and retrieve from the databank 15, relevant image information which may then be displayed in the windows 12a to 12f displayed on the display screen 11.

If a user desires to see more of any of the properties displayed in the windows 12a to 12f, additional or alternative images of the property or relating to the property may be retrieved from the databank 15, e.g. by a user touching the relevant window 12a to 12f.

In one example, by touching a relevant window 12a, the display screen 11 is caused to display a larger window than windows 12a to 12f. Simultaneously, a floor plan or map of the property may be displayed by the screen 11. The larger window may display a tour of the property, and the floor plan or map may indicate to the user which part of the property is being viewed. If desired, a user may choose to see an image of a particular room, for example, by touching the floor plan or map in an appropriate place of the selection area 13. Alternatively, parts of a property depicted by a map or floor plan displayed on the system, e.g. “kitchen” or “garden” may be indicated by virtual selection buttons with appropriate indicia displayed e.g. in the selection area. Thus by touch selecting an appropriate virtual button, an image corresponding to the selected property part, may be displayed.

In each case if desired, simultaneously or subsequently to viewing images of the property, textual information may be displayed on the screen 11.

To update the information in the databank 15, a connection 20 may be provided, e.g. via a dedicated or dial-up telecommunications network 21, so that data from a remote data store may be uploaded into the databank 15I FIG. 2 shows a similar display system to that described with reference to FIG. 1, but instead of having a single screen 11 to display both the windows 12a to 12f and the selection area 13, a main screen 21 is provided, which may be a large plasma screen, and a smaller e.g. L.C.D., ancillary screen 23 is provided for displaying the selection area.

In FIG. 3, a side cross sectional view of the FIG. 1 screen 11 is illustrated. The screen 11 is mounted by an appropriate support structure (not shown), immediately behind a window pane 30 of an estate agent's shop window, but between the pane 30 and the screen, there is a touch sensitive assembly 32, being an encapsulated transparent capacititive screen. Such an assembly typically includes a grid of thin conductors encapsulated in e.g. a glass or other insulating, see through material. In the event that the exterior of the pane 30 is touched, a change in capacitance at a local position of the grid is sensed, and thus a signal relating to the position where the grid has been touched, is sent to the micoprocessor 16 which may react as described above.

In FIG. 4, an alternative touch sensitive arrangement 42 is illustrated. In this example, the grid of thin conductors 43 is adhered directly to the interior surface of the pane 30, with the screen 11 mounted immediately behind.

The FIG. 4 arrangement is perhaps more suitable with a FIG. 1 type system where the display screen 11 is relatively small. Where the main display screen 11 is much larger, as in the FIG. 2 arrangement, the FIG. 3 touch sensitive arrangement is more applicable.

Various modificationss may be made without depairing from the scope of the invention.

For example, the particular screen 11 layout shown is purely illustrative, as is the layout of the selection area 13. For example “buttons” may be displayed in adjacent to the windows 12a to 12f and may enable moving images to be scrolled backwards and forwards or otherwise manipulated, e.g. faster and slower, or zoomed in and out, in addition to providing selection criteria to the microprocessor 16.

Although the illustrative embodiments have been described in relation to an estate agent's use of the system 10, the system may of course be adapted for use in any other circumstances where it is desired to display alternative images and provide for interactivity with a user.

Because the system relies on touch sensitive control, there is little potential for a user to misuse the system, for example by misusing physical control buttons.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A display system for displaying simultaneously multiple images, whilst providing a user of the system with the facility to select the images to be displayed, the system including a display screen, means to display on the display screen a plurality of windows, there being a databank of data files, each data file including image data relating to one or more images each of which is displayable in a window of the display screen, means to display on the display screen at least one selection area, means to sense when the or a part of the selection area has been touch selected by a user, the system responding by displaying in a window, a corresponding image.

2. A system according to claim 1 wherein the display screen is adapted to be mounted on or immediately adjacent to a shop window, so that parts of the selection area of the display screen may be touch selected by touching the shop window.

3. A system according to claim 1 wherein the images which are displayed in the windows, are moving images, the images leaving been previously obtained by recording the images with one or more video cameras.

4. A system according to claim 1 wherein the images are each tours through parts of a property.

5. A system according to claim 4 wherein a part of the property from where a tour is commenced is selectable by a user touching a part of the selection area which indicates the selected part.

6. A system according to claim 4 wherein different parts of a property are depicted by a map or floor plan displayed on the screen, and in the selection area means are provided to enable a user to touch select a part of the properly from where the user requires to commence a tour.

7. A system according to claim 1 wherein the selection area is adapted so that by touching one or more pails of the selection area, an image being displayed is manipulated.

8. A system according to claim 1 wherein the databank of data files is updated by uploading data files from a data store, via a dedicated or dial-up telecommunications network.

9. A system according to claim 1 wherein the display screen is an L.C.D. or plasma type display screen mounted immediately adjacent a shop window pane, but with a transparent touch sensitive means between screen and the window pane, the touch sensitive means being connected to a means which is capable of sensing which part of the selection area of the display screen has been touched, and providing an appropriate signal to a processing means which responds by recalling relevant data from the databank to the or a window displayed on the display screen.

10. A system according to claim 1 wherein the display screen is mounted immediately adjacent a shop window panes but with a transparent capacititive grid layer adhered directly to an interior surface of the window pane with) the screen mounted directly behind, the capacititive layer being connected to a means which is capable of sensing which part of the selection area of the display screen has been touched, and providing an appropriate signal to a processing means which responds by recalling relevant data from the databank to the or a window displayed on the display screen.

11. A display system for displaying simultaneously multiple images, whilst providing a user of the system with the facility to select the images to be displayed, the system including a main display screen, means to display on the main display screen a plurality of windows, there being a databank of data files, each data file including image data relating to one or more images which is displayable in a window displayed on the display screen, means to display oil a separate ancillary display screen at least one selection area, means to sense When the or a part of the selection area has been touch selected by a user, and in response, to display in a window of the main screen, a corresponding image.

12. A display system according to claim 11 wherein the images which are displayed in the windows, are moving images which have previously been recorded by one or more video cameras.

13. A method of displaying multiple images on a display system, the images being digital images stored in data files in a data bank, the method including displaying on a display screen, a window, and displaying on the or another display screen, at least one touch sensitive selection area, touching a or a part of the selection area to select an image or images to be displayed in the window or the windows displayed on the display screen, and recalling image data from the data bank to enable the image or images to be displayed.

14. A method of displaying images of properties in an estate agent's shop window, including the steps of collecting image data of properties with one or more video cameras, loading the image data on to a databank of a display system the display system including a display screen, means to display on the display screen a plurality of windows, there being a databank of data files, each data file including image data relating to one or more images each of which is displayable in a window of the display screen, means to display on the display screen at least one selection area, means to sense when the or a part of the selection area has been touch selected by a user, the system responding by displaying in a window, a corresponding image, and simultaneously displaying a plurality of images in windows of a display screen through the shop window.

15. A method of displaying images of properties on one or more display screens, including displaying a window in which an image of a properly is to be displayed, displaying a map or floor plan of the property, providing touch-sensitive means whereby pates depicted by the map or floor plan are identified in a selection are displayed by the screen, selecting a part of the property of which it is desired to view an image by touching a selected part of the selection area corresponding to a part depicted by thee map or floor plan, recalling from a data bank of image files, image data corresponding to the selected part of the property, and displaying in the displayed window, an image of the selected part of the property.
